(19) United States
(12) Patent Application Publication
(10) Pub. No.: US 2008/0088974 A1
(43) Pub. Date: Apr. 17, 2008

(54) Head slider reducing probability of collision against recording medium and method of making the same

(75) Inventor: Masaki Kameyama, Kawasaki (JP)

Correspondence Address: Patrick G. Burns;GREER, BURNS & CRAIN, LTD., Suite 2500, 300 South Wacker Drive, Chicago, IL, 60606, US

(73) Assignee: Fujitsu Limited, Kawasaki-shi (JP)

(21) Appl. No.: 11/789,077

(22) Filed: Apr. 23, 2007

(30) Foreign Application Priority Data
Oct. 17, 2006 (JP) 2006-282938

(51) Int. Cl. G11B 5/60

(52) U.S. Cl. 360/230

(57) ABSTRACT

The head slider allows the first protection film having the first thickness to cover over the top surface of the rail. The second protection film having the first thickness covers over the surface of the insulating non-magnetic film at a position downstream of the rail. The third protection film having the second thickness smaller than the first thickness covers over the write gap of the head element at a position downstream of the rail. Even when the head element protrudes from the surface of the insulating non-magnetic film, the third protection film is prevented from getting closer to the recording medium beyond the first and second protection films. The head element is prevented from contacting with the recording medium. This results in avoidance of damages to the head slider.

### BACKGROUND OF THE INVENTION

1. Field of the Invention

The present invention relates to a head slider incorporated in a storage medium drive such as a hard disk drive, HDD.

2. Description of the Prior Art

A flying head slider is employed in a hard disk drive. The flying head slider includes a slider body and an insulating non-magnetic film overlaid on the outflow end surface of the slider body, for example. A head element or electromagnetic transducer is embedded in the insulating non-magnetic film. The electromagnetic transducer is covered with a protection film. Magnetic flux is leaked out of the electromagnetic transducer in response to supply of a writing current to a magnetic coil incorporated in the electromagnetic transducer. The leaked magnetic flux is applied to a magnetic recording disk. Magnetic bit data is in this manner written onto the magnetic recording disk.

The magnetic coil gets heated during the writing operation. This results in expansion of the insulating non-magnetic film. The electromagnetic transducer is thus forced to protrude toward the magnetic recording disk. The flying head slider is eventually brought in contact with the magnetic recording disk. The impact of the contact induces deterioration of the characteristics of the electromagnetic transducer. The contact with the magnetic recording disk also causes abrasion of the protection film. This results in corrosion of the electromagnetic transducer.

### SUMMARY OF THE INVENTION

It is accordingly an object of the present invention to provide a head slider capable of preventing damage to a head element. It is also an object of the present invention to provide a method of making a head slider, significantly contributing to realization of the aforementioned head slider.

According to a first aspect of the present invention, there is provided a head slider comprising: a slider body defining a medium-opposed surface opposed to a recording medium at a distance; an insulating non-magnetic film over laid on the outflow end surface of the slider body; a rail formed on the medium-opposed surface of the slider body, the rail extending to the outflow end of the slider body; a head element embedded in the insulating non-magnetic film at a position downstream of the rail, the head element having at least a write gap exposed at the surface of the insulating non-magnetic film; a first protection film having a first thickness, the first protection film overlaid on the top surface of the rail; a second protection film having the first thickness, the second protection film formed continuous with the first protection film on the surface of the insulating non-magnetic film at a position downstream of the rail; and a third protection film having a second thickness smaller than the first thickness, the third protection film cover over the write gap at a position downstream of the rail.

The head slider allows the first protection film having the first thickness to cover over the top surface of the rail. The second protection film having the first thickness likewise covers over the surface of the insulating non-magnetic film at a position downstream of the rail. The third protection film having the second thickness smaller than the first thickness covers over the write gap of the head element at a position downstream of the rail. Even when the head element protrudes from the surface of the insulating non-magnetic film, the third protection film is prevented from getting closer to the recording medium beyond the first and second protection films. The head element is prevented from contacting with the recording medium. This results in avoidance of damages to the head slider.

Moreover, since the third protection film is designed to have a smaller thickness at a position downstream of the rail, the head element is allowed to get closer to the recording medium. The head element is allowed to write magnetic bit data onto the recording medium with a higher accuracy. Likewise, the head element is allowed to read out magnetic bit data from the recording medium. The first and second protection films serve to prevent the head element from contacting with dust on the recording medium, for example. The head slider may be employed in a storage medium drive, for example.

According to a second aspect of the present invention, there is provided a head slider comprising: a slider body defining a medium-opposed surface opposed to a recording medium at a distance; an insulating non-magnetic film overlaid on the outflow end surface of the slider body; a rail formed on the medium-opposed surface of the slider body, the rail extending to the outflow end of the slider body; a first protection film overlaid on the top surface of the rail; a second protection film formed continuous with the first protection film, the second protection film overlaid on the surface of the insulating non-magnetic film at a position downstream of the rail; a recess defined at least partly in the second protection film; and a head element embedded in the insulating non-magnetic film at a position downstream of the rail, the head element having at least a write gap located in the recess.

The recess is formed in the second protection film in the head slider. The write gap of the head element is located inside the recess. Even when the head element protrudes from the surface of the insulating non-magnetic film, the second protection film inside the recess cannot get closer to the recording medium than the second protection film outside the recess. The head element is thus prevented from contacting with the recording medium. This results in avoidance of damages to the head slider.

Moreover, the recess enables reduction in the thickness of the second protection film covering over the write gap. When the head element protrudes, the distance can be reduced between the head element and the recording medium. The head element is allowed to write magnetic bit data onto the recording medium with a higher accuracy. Likewise, the head element is allowed to read out magnetic bit data from the recording medium. In addition, the recess serves to prevent the head element from contacting with dust on the recording medium, for example.

The thickness of the second protection film may be set smaller than that of the first protection film in the head slider. The thicknesses of the first and second protection films may get reduced at a position closer to the outflow end of the rail. The head slider may be employed in a storage medium drive, for example.

According to a third aspect of the present invention, there is provided a method of making a head slider, comprising: forming a protection film on the top surface of a rail defined on a slider body, the protection film covering over the tip end of a head element at a position downstream of the rail, the head element exposed at the surface of an insulating non-magnetic film overlaid on the outflow end surface of the slider body; and flattening the surface of the protection film on the insulating non-magnetic film while the head element is forced to protrude from the surface of the insulating non-magnetic film.

The method allows the head element to protrude from the surface of the insulating non-magnetic film. The protrusion of the head element induces protrusion of the protection film. The protection film is ground. When the head element is released from establishment of the protrusion, a recess is formed in the protection film. The aforementioned head slider is produced in this manner.

### BRIEF DESCRIPTION OF THE DRAWINGS

The above and other objects, features and advantages of the present invention will become apparent from the following description of the preferred embodiments in conjunction with the accompanying drawings, wherein:

FIG. 1 is a plan view schematically illustrating the structure of a hard disk drive, HDD, as an example of a storage medium drive according to the present invention;

FIG. 2 is a perspective view schematically illustrating a flying head slider according to a first embodiment of the present invention;

FIG. 3 is a front view illustrating the structure of the flying head slider observed at a medium-opposed surface;

FIG. 4 is a sectional view taken along the line 4-4 in FIG. 3;

FIG. 5 is an enlarged partial plan view schematically illustrating a rear rail observed at the medium-opposed surface;

FIG. 6 is a sectional view taken along the line 6-6 in FIG. 5;

FIG. 7 is an enlarged partial sectional view schematically illustrating the flying head slider during flight;

FIG. 8 is an enlarged partial plan view schematically illustrating a rear rail observed at the medium-opposed surface in a flying head slider according to a second embodiment of the present invention;

FIG. 9 is a sectional view taken along the line 9-9 in FIG. 8;

FIG. 10 is an enlarged partial sectional view schematically illustrating the flying head slider during flight;

FIG. 11 is an enlarged partial sectional view schematically illustrating a method of making the flying head slider;

FIG. 12 is an enlarged partial sectional view schematically illustrating grinding of a protection film.

FIG. 13 is an enlarged partial sectional view, corresponding to FIG. 9, schematically illustrating a rear rail in a flying head slider according to a third embodiment of the present invention; and

FIG. 14 is an enlarged partial sectional view schematically illustrating a flying head slider according to a fourth embodiment of the present invention during flight.

### DESCRIPTION OF THE PREFERRED EMBODIMENTS

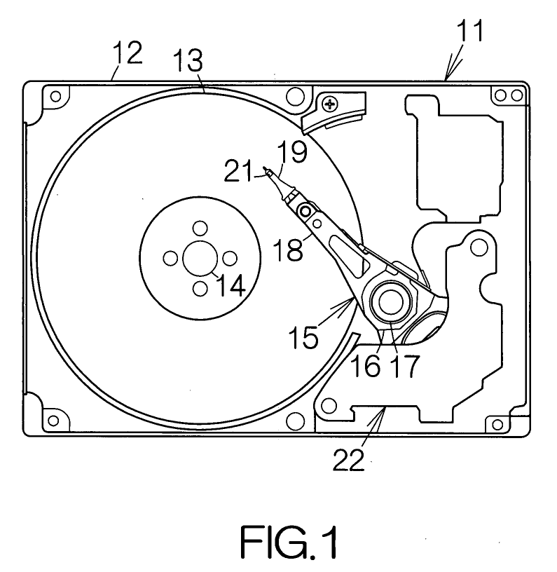

FIG. 1 schematically illustrates the structure of a hard disk drive, HDD, 11 as an example of a storage medium drive or a storage device according to the present invention. The hard disk drive 11 includes a box-shaped enclosure body 12 defining an inner space in the form of a flat parallelepiped, for example. The enclosure body 12 may be made of a metallic material such as aluminum, for example. Molding process may be employed to form the enclosure body 12. An enclosure cover, not shown, is coupled to the enclosure body 12. An inner space is defined between the enclosure body 12 and the enclosure cover. Pressing process may be employed to form the enclosure cover out of a plate material, for example. The enclosure body 12 and the enclosure cover in combination establish an enclosure.

At least one magnetic recording disk 13 as a storage medium is enclosed in the enclosure body 12. The magnetic recording disk or disks 13 are mounted on the driving shaft of a spindle motor 14. The spindle motor 14 drives the magnetic recording disk or disks 13 at a higher revolution speed such as 5,400 rpm, 7,200 rpm, 10,000 rpm, 15,000 rpm, or the like.

A carriage 15 is also enclosed in the enclosure body 12. The carriage 15 includes a carriage block 16. The carriage block 16 is supported on a vertical support shaft 17 for relative rotation. Carriage arms 18 are defined in the carriage block 16. The carriage arms 18 are designed to extend in the horizontal direction from the vertical support shaft 17. The carriage block 16 may be made of aluminum, for example. Extrusion molding process may be employed to form the carriage block 16, for example.

A head suspension 19 is fixed to the tip end of the individual carriage arm 18. The head suspension 19 is designed to extend forward from the tip end of the carriage arm 18. A predetermined urging force is applied to the head suspension 19 toward the surface of the magnetic recording disk 13. A flying head slider 21 is fixed to the tip end of the head suspension 19. A head element or electromagnetic transducer, not shown, is mounted on the flying head slider 21.

When the magnetic recording disk 13 rotates, the flying head slider 21 is allowed to receive an airflow generated along the rotating magnetic recording disk 13. The airflow serves to generate a positive pressure or a lift as well as a negative pressure on the flying head slider 21. The flying head slider 21 is thus allowed to keep flying above the surface of the magnetic recording disk 13 during the rotation of the magnetic recording disk 13 at a higher stability established by the balance between the urging force of the head suspension 19 and the combination of the lift and the negative pressure.

A power source such as a voice coil motor, VCM, 22 is coupled to the carriage block 16. The voice coil motor 22 serves to drive the carriage block 16 around the vertical support shaft 17. The rotation of the carriage block 16 allows the carriage arms 18 to swing. When the carriage arm 18 swings around the vertical support shaft 17 during the flight of the flying head slider 21, the flying head slider 21 is allowed to move along the radial direction of the magnetic recording disk 13. The electromagnetic transducer on the flying head slider 21 is positioned right above a target recording track on the magnetic recording disk 13 through the movement of the flying head slider 21.

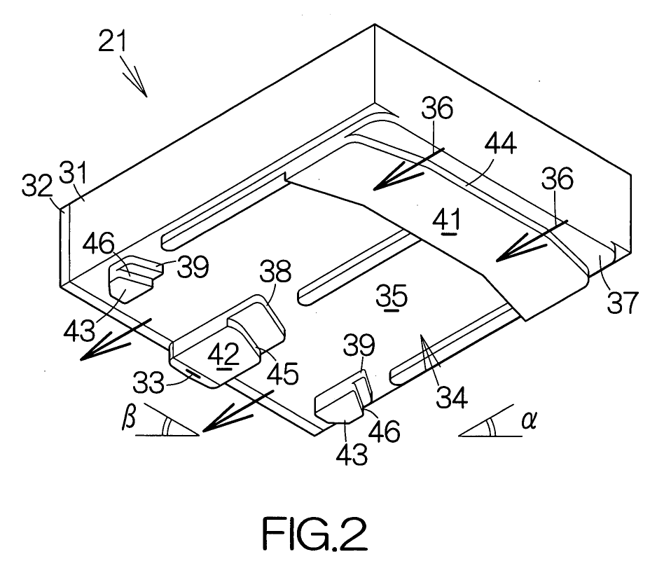

FIG. 2 illustrates a first embodiment of the flying head slider 21. The flying head slider 21 includes a slider body 31 in the form of a flat parallelepiped, for example. An insulating non-magnetic film, namely a head protection film 32, is overlaid on the outflow or trailing end surface of the slider body 31. The aforementioned electromagnetic transducer 33 is embedded in the head protection film 32. The electromagnetic transducer 33 will be described later in detail.

The slider body 31 may be made of a hard material such as Al₂O₃—TiC. The head protection film 32 is made of a relatively soft material such as Al₂O₃ (alumina). A medium-opposed surface or bottom surface 34 is defined over the slider body 31 so as to face the magnetic recording disk 13 at a distance. A flat base surface 35 as a reference surface is defined on the bottom surface 34. When the magnetic recording disk 13 rotates, airflow 36 flows along the bottom surface 34 from the inflow or front end toward the outflow or rear end of the slider body 31.

A front rail 37 is formed on the bottom surface 34 of the slider body 31. The front rail 37 stands upright from the base surface 35 of the bottom surface 34 near the inflow end of the slider body 31. The front rail 37 is designed to extend along the inflow end of the base surface 35 in the lateral direction of the slider body 31. A rear rail 38 is likewise formed on the bottom surface 34 of the slider body 31. The rear rail 38 stands upright from the base surface 35 of the bottom surface 34 near the outflow end of the slider body 31. The rear rail 38 is located at the intermediate position in the lateral direction of the slider body 31.

A pair of auxiliary rear rails 39, 39 is likewise formed on the bottom surface 34 of the slider body 31. The auxiliary rear rails 39, 39 stand upright from the base surface 35 of the bottom surface 34 near the outflow end of the slider body 31. The auxiliary rear rails 39, 39 are located along the sides of the base surface 35, respectively. The auxiliary rear rails 39, 39 are thus distanced from each other in the lateral direction of the slider body 31. The rear rail 38 is located in a space between the auxiliary rear rails 39, 39.

Air bearing surfaces 41, 42, 43 are defined on the top surfaces of the rails 37, 38, 39, respectively. Steps 44, 45, 46 connect the inflow ends of the air bearing surfaces 41, 42, 43 to the top surfaces of the rails 37, 38, 39, respectively. The bottom surface 34 of the flying head slider 21 is designed to receive the airflow 36 generated along the rotating magnetic recording disk 13. The steps 44, 45, 46 serve to generate a larger positive pressure or lift at the air bearing surfaces 41, 42, 43, respectively. Moreover, a larger negative pressure is generated behind the front rail 37 or at a position downstream of the front rail 37. The negative pressure is balanced with the lift so as to stably establish the flying attitude of the flying head slider 21.

A larger positive pressure or lift is generated at the front air bearing surface 41 as compared with the air bearing surfaces 42, 43 in the flying head slider 21. When the slider body 31 flies above the surface of the magnetic recording disk 13, the slider body 31 can be kept at an inclined attitude defined by a pitch angle α. The term “pitch angle” is used to define an inclined angle in the longitudinal direction of the slider body 31 along the direction of the airflow 36.

A lift is equally generated in the pair of auxiliary air bearing surfaces 43, 43. This serves to suppress change in a roll angle β of the flying head slider 21 during the flight. The auxiliary air bearing surfaces 43, 43 are thus prevented from contact or collision against the magnetic recording disk 13. The term “roll angle” is used to define an inclined angle in the lateral direction of the slider body 31 perpendicular to the direction of the airflow 36.

A protection film, not shown, is formed on the surface of the slider body 31 at the air bearing surfaces 41, 42, 43, for example. The aforementioned electromagnetic transducer 33 has a read gap and a write gap exposed on the surface of the slider body 31 near the outflow end of the air bearing surface 42. The protection film covers over the read and write gaps of the electromagnetic transducer 33. The protection film may be made of diamond-like-carbon (DLC), for example. It should be noted that the flying head slider 21 may take any shape or form different from the described one.

FIG. 3 illustrates the bottom surface 34 of the flying head slider 21 in detail. The electromagnetic transducer 33 includes a write head 61 and a read head 62. As conventionally known, the write head 61 utilizes a magnetic field generated at a magnetic coil for writing binary data into the magnetic recording disk 13, for example. The read head 62 is usually designed to detect binary data based on variation in the electric resistance in response to the inversion of polarization in the magnetic field applied from the magnetic recording disk 13.

The read head 62 includes a magnetoresistive film 63, such as a giant magnetoresistive (GMR) element, a tunnel-junction magnetoresistive (TMR) element, or the like. The magnetoresistive film 63 is interposed between a pair of electrically-conductive layers or upper and lower shielding layers 64, 65. The upper shielding layer 64 extends along a plane parallel to the lower shielding layer 65. The upper and lower shielding layers 64, 65 may be made of a magnetic material such as FeN, NiFe, or the like.

The magnetoresistive film 63 is embedded in an insulating layer 66 covering over the upper surface of the lower shielding layer 65. The insulating layer 66 is made of Al₂O₃, for example. The upper shielding layer 64 extends along the upper surface of the insulating layer 66. The magnetoresistive film 63 is electrically connected separately to the lower and upper shielding layers 65, 64. The gap between the upper and lower shielding layers 64, 65 determines a linear resolution of magnetic recordation on the magnetic recording disk 13 along the recording track.

The write head 61 includes upper and lower magnetic pole layers 67, 68. The front ends of the upper and lower magnetic pole layers 67, 68 are exposed at the air bearing surface 42. The lower magnetic pole layer 68 extends along a plane parallel to the upper shielding layer 64. A magnetic front end layer 69 is formed on the lower magnetic pole layer 68. The front end of the magnetic front end layer 69 is exposed at the air bearing surface 42. The upper and lower magnetic pole layers 67, 68 and the magnetic front end layer 69 may be made of FeN, NiFe, or the like. The upper and lower magnetic pole layers 67, 68 and the magnetic front end layer 69 in combination serve as a magnetic core of the write head 61.

The magnetic front end layer 69 is opposed to the upper magnetic pole layer 67. A non-magnetic gap layer 71 made of Al₂O₃ or the like is interposed between the upper magnetic pole layer 67 and the magnetic front end layer 69. As conventionally known, when a magnetic field is generated at the aftermentioned magnetic coil, the non-magnetic gap layer 71 serves to leak a magnetic flux out of the bottom surface 34 between the upper and lower magnetic pole layers 67, 68. The leaked magnetic flux forms a magnetic field for recordation. Specifically, a write gap is defined between the upper magnetic pole layer 67 and the magnetic front end layer 69.

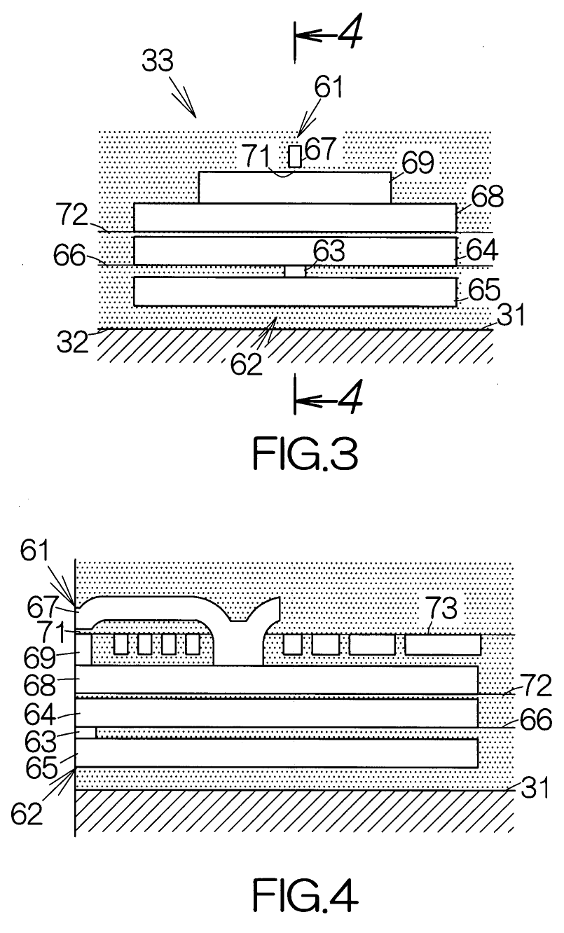

Referring also to FIG. 4, the lower magnetic pole layer 68 is formed on an insulating layer 72 overlaid on the upper shielding layer 64 by a constant thickness. The insulating layer 72 serves to establish a magnetic isolation between the lower magnetic pole layer 68 and the upper shielding layer 64. The magnetic coil, namely a thin film coil pattern 73, is formed on the lower magnetic pole layer 68. The thin film coil pattern 73 is embedded in an insulating layer 72. The thin film coil pattern 73 may be made of Cu, for example. The aforementioned upper magnetic pole layer 67 is formed on the upper surface of the non-magnetic gap layer 71. The rear end of the upper magnetic pole layer 67 is magnetically connected to the rear end of the lower magnetic pole layer 68 at the center of the thin film coil pattern 73. The upper and lower magnetic pole layers 67, 68 in combination serve as a magnetic core extending through the center of the thin film coil pattern 73.

As shown in FIG. 5, a first protection film 81 is overlaid on the top surface of the rear rail 38 in the slider body 31. Second protection films 82 are overlaid on the surface of the head protection film 32 at positions downstream of the rear rail 38. The second protection films 82 are spaced from each other at a predetermined interval in the direction parallel to the inflow end of the head protection film 32. The electromagnetic transducer 33 is located between the second protection films 82, 82. The second protection films 82 are formed continuous with the first protection film 81. A third protection film 83 is formed on the surface of the head protection film 32 outside the second protection films 82. The third protection film 83 is designed to cover over the electromagnetic transducer 33. The third protection film 83 is formed continuous with the first and second protection films 81, 82. The first protection film 81 is formed at a position upstream of the electromagnetic transducer 33.

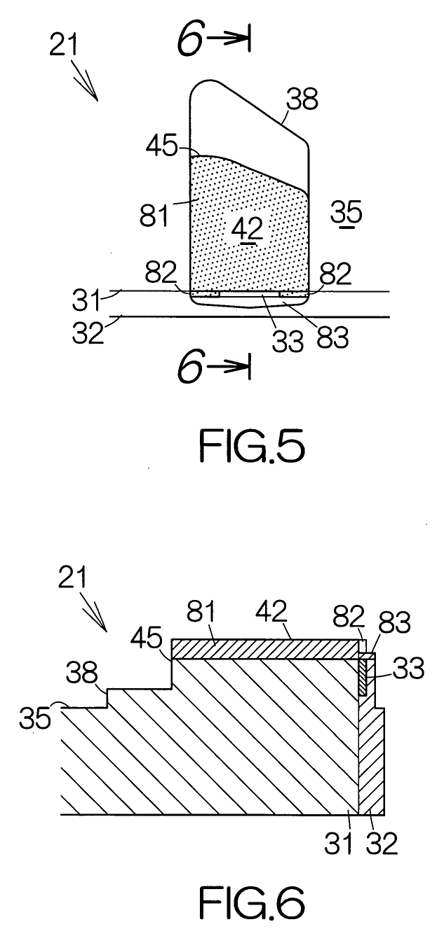

Referring also to FIG. 6, the thickness of the first and second protection films 81, 82 is set at a first thickness. The first thickness may be set at 5 nm approximately, for example. The thickness of the third thickness 83 is set at a second thickness. The second thickness may be set at 3 nm approximately, for example. The difference between the first and second thicknesses may be set equal to the amount of the maximum protrusion of the electromagnetic transducer 33.

Now, assume that binary data is to be written onto the magnetic recording disk 13. The flying head slider 21 is kept in the inclined attitude defined by a predetermined pitch angle α during the rotation of the magnetic recording disk 13. A writing current is supplied to the thin film coil pattern 73. The thin film coil pattern 73 thus gets heated. This results in expansion of the head protection film 32 in the vicinity of the thin film coil pattern 73. The electromagnetic transducer 33 is in this manner forced to protrude toward the magnetic recording disk 13.

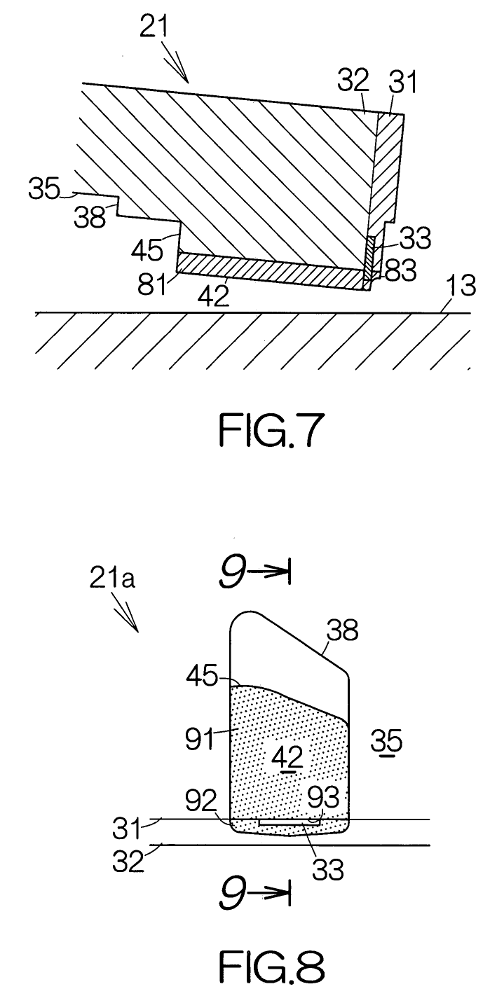

The protrusion of the electromagnetic transducer 33 induces protrusion of the third protection film 83 toward the magnetic recording disk 13, as shown in FIG. 7. Since the amount of difference between the first and second thicknesses is set equal to the amount of the maximum protrusion of the electromagnetic transducer 33, the surface of the third protection film 83 become flush with the surfaces of the first and second protection films 81, 82 when the electromagnetic transducer 33 protrudes farthest. The write gap of the write head 61 applies a magnetic field to the magnetic recording disk 13. Binary bit data is in this manner written onto the magnetic recording disk 13.

The third protection film 83 covering over the electromagnetic transducer 33 has the second thickness smaller than the first thickness of the first and second protection films 81, 82 in the flying head slider 21. When the electromagnetic transducer 33 or third protection film 83 protrudes, the surfaces of the first to third protection films 81, 82, 83 extend within a plane. The electromagnetic transducer 33 is prevented from protruding from the air bearing surface 42. The electromagnetic transducer 33 is thus prevented from contact with or collision against the magnetic recording disk 13. This results in avoidance of damages to the electromagnetic transducer 33.

Moreover, since the third protection film 83 of the smaller thickness is formed at a position downstream of the rear rail 38, the flying head slider 21 can get closer to the magnetic recording disk 13. The write head 61 can write binary data onto the magnetic disk 13 with a higher accuracy. Likewise, the read head 62 can read out binary data from the magnetic recording disk 13 with a higher accuracy. Furthermore, the first and second protection films 81, 82 serve to prevent the electromagnetic transducer 33 from contacting with dust on the magnetic recording disk 13, for example.

Next, a brief description will be made on a method of making the flying head slider 21. An Al₂O₃ (alumina) film is first overlaid on a wafer made of Al₂O₃—TiC. An electromagnetic transducer is embedded in the Al₂O₃ film. A wafer bar is cut out of the wafer. A first DLC film is formed on the cut surface of the wafer bar. The thickness of the first DLC film is set at the aforementioned second thickness. A resist film is formed on the surface of the first DLC film over a region corresponding to the extent of the third protection film 83. A second DLC film is formed on the surface of the first DLC film outside the resist film. The first to third protection films 81, 82, 83 are formed in this manner. The front rail 37 and the rear rail 38 are subsequently formed. The bottom surface 34 is shaped in this manner. The slider body 31 is then cut out of the wafer bar. The flying head slider 21 is produced in this manner.

As shown in FIG. 8, a flying head slider 21a according to a second embodiment of the present invention may be employed in the hard disk drive 11 in place of the aforementioned flying head slider 21. A first protection film 91 is overlaid on the top surface of the rear rail 38 in the slider body 31 of the flying head slider 21a. A second protection film 92 is overlaid on the surface of the head protection film 32 at a position downstream of the rear rail 38. The second protection film 92 is formed continuous with the first protection film 91. A recess 93 is defined in the second protection film 92. The electromagnetic transducer 33 is located inside the recess 93. Here, at least the write gap of the electromagnetic transducer 33 may be located inside the recess 93. The recess 93 may extend in the lateral direction of the slider body 31 along the inflow end of the head protection film 32, for example.

Referring also to FIG. 9, the first protection film 91 is designed to have a first thickness. The first thickness may be set at 5 nm approximately, for example. The second protection film 92 may be designed to have a second thickness. The second thickness is set at 5 nm approximately, for example. The second protection film 92 inside the recess 93 is designed to have a third thickness. The third thickness may be set at 3 nm approximately, for example. The difference between the first or second thickness and the third thickness, namely the depth of the recess 93, may be set equal to the amount of the maximum protrusion of the electromagnetic transducer 33. Like reference numerals are attached to the structure or components equivalent to those of the aforementioned flying head slider 21.

Now, assume that binary data is to be written onto the magnetic recording disk 13. The flying head slider 21a is kept in the inclined attitude defined by a predetermined pitch angle α during the rotation of the magnetic recording disk 13. A writing current is supplied to the thin film coil pattern 73. The thin film coil pattern 73 thus gets heated. This results in expansion of the head protection film 32 in the vicinity of the thin film coil pattern 73. The electromagnetic transducer 33 is in this manner forced to protrude toward the magnetic recording disk 13.

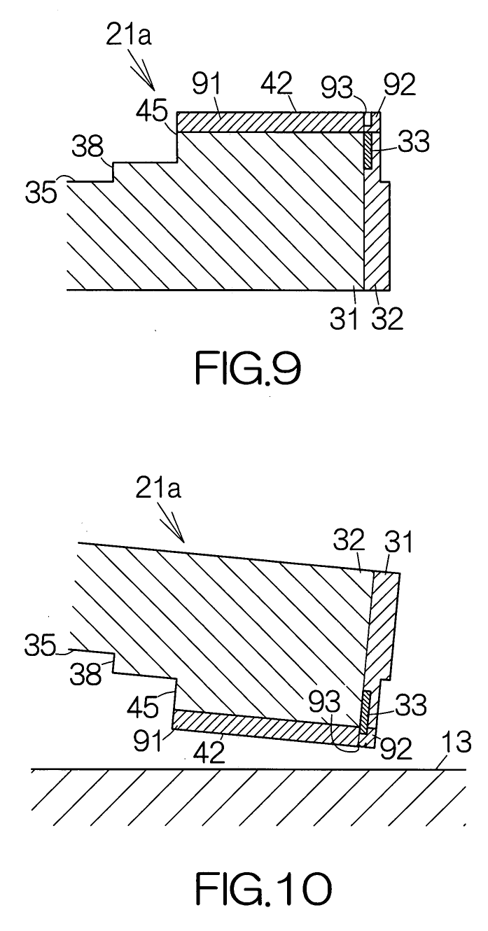

The protrusion of the electromagnetic transducer 33 induces a reduction in the depth of the recess 93, as shown in FIG. 10. Since the depth of the recess 93 is set equal to the amount of the maximum protrusion of the electromagnetic transducer 33, the recess 93 disappears when the electromagnetic transducer 33 protrudes farthest. The write gap of the write head 61 applies a magnetic field to the magnetic recording disk 13. Binary bit data is in this manner written onto the magnetic recording disk 13.

The recess 93 is formed in the second protection film 92 in the flying head slider 21a. The electromagnetic transducer 33 is located inside the recess 93. Protrusion of the electromagnetic transducer 33 or second protection film 92 makes the recess 92 disappear. The electromagnetic transducer 33 is prevented from protruding from the air bearing surface 42. The electromagnetic transducer 33 is in this manner prevented from contact with the magnetic recording disk 13. This results in avoidance of damages to the electromagnetic transducer 33.

Moreover, the recess 93 enables reduction in the thickness of the second protection film 92 covering over the front end of the electromagnetic transducer 33. When the electromagnetic transducer 33 protrudes, the distance can be reduced between the electromagnetic transducer 33 and the magnetic recording disk 13. The write head 61 can write binary data onto the magnetic disk 13 with a higher accuracy. Likewise, the read head 62 can read out binary data from the magnetic recording disk 13 with a higher accuracy. Furthermore, the recess 93 serves to prevent the electromagnetic transducer 33 from contacting with dust on the magnetic recording disk 13, for example.

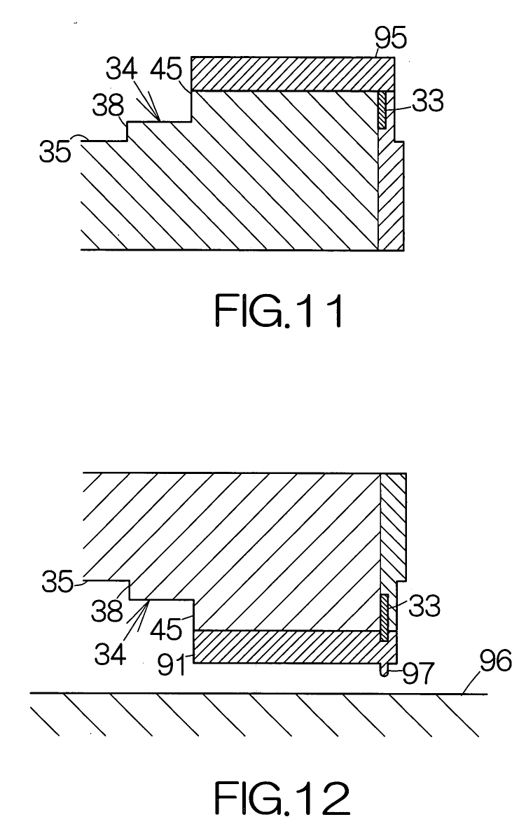

Next, a brief description will be made on a method of making the flying head slider 21a. An Al₂O₃ (alumina) film is first overlaid on a wafer made of Al₂O₃—TiC. An electromagnetic transducer is embedded in the Al₂O₃ film. A wafer bar is cut out of the wafer. A DLC film is formed on the cut surface of the wafer bar. The cut surface is then shaped into the bottom surface 34. The front and rear rails 37, 38 are thus formed. As shown in FIG. 11, a DLC film 95 is in this manner formed on the top surface of the rear rail 38. The thickness of the DLC film 95 may be set larger than the aforementioned first and second thicknesses.

The bottom surface 34 is opposed to a faceplate 96, as shown in FIG. 12. Electric current is supplied to the thin film coil pattern 73 of the electromagnetic transducer 33, for example. The electromagnetic transducer 33 protrudes farthest in response to the supply of electric current. A protrusion 97 is formed on the DLC film 95 because of the protrusion of the electromagnetic transducer 33 out of the surface of the head protection film 32. The DLC film 95 is urged against the faceplate 96. The surface of the DLC film 95 is subjected to polishing. The protrusion 97 is in this manner removed from the DLC film 95.

The electromagnetic transduction characteristic of the electromagnetic transducer 33 may be observed to establish the predetermined thickness of the DLC film 95. A magnetic recording layer, not shown, is formed on the surface of the faceplate 96. Binary data is written into the magnetic recording layer, for example. The thickness of the DLC film 95 gets reduced while the DLC film 95 is urged against the moving faceplate 96. The resolution of the read head 62 get improved in response to reduction in the thickness of the DLC film 95. The relationship is previously observed between the resolution and the thickness of the DLC film 95. The observation on the resolution during the grinding enables acquisition of the thickness of the DLC film 95, namely the first and second protection film 91, 92.

When the thickness of the DLC film 95 reaches a predetermined thickness in the aforementioned manner, the DLC film 95 is separated from the faceplate 96. The supply of electric current to the thin film coil pattern 73 is terminated. The electromagnetic transducer 33 retracts. The DLC film 95 is largely ground at the protrusion 97 on the electromagnetic transducer 33. When the electromagnetic transducer 33 retracts, the aforementioned recess 93 is defined in the DLC film 95. The slider body 31 is then cut out of the wafer bar. The flying head slider 21a is produced in this manner.

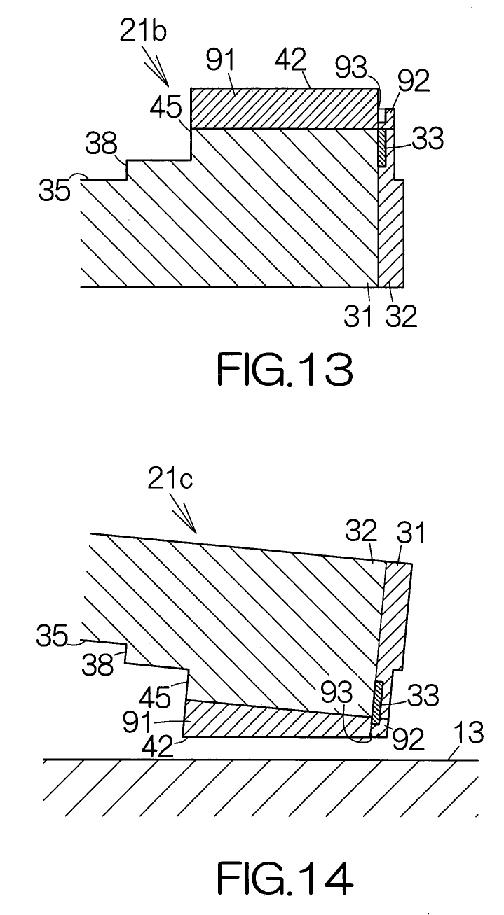

As shown in FIG. 13, a flying head slider 21b according to a third embodiment of the present invention may be employed in the hard disk drive 11 in place of the flying head sliders 21, 21a. The second thickness of the second protection film 92 is set smaller than the first thickness of the first protection film 91 in the flying head slider 21b. Here, the second thickness may be set at 5 nm approximately, for example. The first thickness may be set at 10 nm approximately, for example. The third thickness is set at 3 nm approximately, for example, in the same manner as described above. Since the first protection film 91 has a relatively large thickness at a position upstream of the electromagnetic transducer 33, the electromagnetic transducer 33 is allowed to enjoy less probability of contacting with the magnetic recording disk 13. Like reference numerals are attached to the structure or components equivalent to those of the aforementioned flying head slider 21a.

As shown in FIG. 14, a flying head slider 21c according to a fourth embodiment of the present invention may be employed in the hard disk drive 11 in place of the flying head sliders 21, 21a, 21b. The first thickness of the first protection film 91 and the second thickness of the second protection film 92 get reduced at a position closer to the outflow end in the flying head slider 21c. When the flying head slider 21c is kept in the inclined attitude defined by a predetermined pitch angle α, a constant distance can be between the surfaces of the first and second protection films 91, 92, namely the air bearing surface 42, and the magnetic recording disk 13. Since the first protection film 91 is in this manner designed to have a relatively large thickness at a position upstream of the electromagnetic transducer 33, the electromagnetic transducer 33 is allowed to enjoy less probability of contacting with the magnetic recording disk 13. Like reference numerals are attached to the structure or components equivalent to those of the aforementioned flying head slider 21a.

What is claimed is:

1. A head slider comprising:
a slider body defining a medium-opposed surface opposed to a recording medium at a distance;
an insulating non-magnetic film overlaid on an outflow end surface of the slider body;
a rail formed on the medium-opposed surface of the slider body, the rail extending to an outflow end of the slider body;
a head element embedded in the insulating non-magnetic film at a position downstream of the rail, the head element having at least a write gap exposed at a surface of the insulating non-magnetic film;
a first protection film having a first thickness, the first protection film overlaid on a top surface of the rail;
a second protection film having the first thickness, the second protection film formed continuous with the first protection film on the surface of the insulating non-magnetic film at a position downstream of the rail; and
a third protection film having a second thickness smaller than the first thickness, the third protection film covering over the write gap at a position downstream of the rail.

2. A storage medium drive comprising:
an enclosure;
a recording medium enclosed in the enclosure; and
a head slider opposed to the recording medium within the enclosure, wherein
a head slider includes:
a slider body defining a medium-opposed surface opposed to the recording medium at a distance;
an insulating non-magnetic film overlaid on an outflow end surface of the slider body;
a rail formed on the medium-opposed surface of the slider body, the rail extending to an outflow end of the slider body;
a head element embedded in the insulating non-magnetic film at a position downstream of the rail, the head element having at least a write gap exposed at a surface of the insulating non-magnetic film;
a first protection film having a first thickness, the first protection film overlaid on a top surface of the rail;
a second protection film having the first thickness, the second protection film formed continuous with the first protection film on the surface of the insulating non-magnetic film at a position downstream of the rail; and
a third protection film having a second thickness smaller than the first thickness, the third protection film covering over the write gap at a position downstream of the rail.

3. A head slider comprising:
a slider body defining a medium-opposed surface opposed to a recording medium at a distance;
an insulating non-magnetic film overlaid on an outflow end surface of the slider body;
a rail formed on the medium-opposed surface of the slider body, the rail extending to an outflow end of the slider body;
a first protection film overlaid on a top surface of the rail;
a second protection film formed continuous with the first protection film, the second protection film overlaid on a surface of the insulating non-magnetic film at a position downstream of the rail;
a recess defined at least partly in the second protection film; and
a head element embedded in the insulating non-magnetic film at a position downstream of the rail, the head element having at least a write gap located in the recess.

4. The head slider according to claim 3, wherein a thickness of the second protection film is set smaller than a thickness of the first protection film.

5. The head slider according to claim 3, wherein thickness of the first and second protection films gets reduced at a position closer to the outflow end of the rail.

6. A storage medium drive comprising:
an enclosure;
a recording medium enclosed in the enclosure; and
a head slider opposed to the recording medium within the enclosure, wherein
a head slider includes:
a slider body defining a medium-opposed surface opposed to a recording medium at a distance;
an insulating non-magnetic film overlaid on an outflow end surface of the slider body;
a rail formed on the medium-opposed surface of the slider body, the rail extending to an outflow end of the slider body;
a first protection film overlaid on a top surface of the rail;
a second protection film formed continuous with the first protection film, the second protection film overlaid on a surface of the insulating non-magnetic film at a position downstream of the rail;
a recess defined at least partly in the second protection film; and
a head element embedded in the insulating non-magnetic film at a position downstream of the rail, the head element having at least a write gap located in the recess.

7. The storage medium drive according to claim 6, wherein a thickness of the second protection film is set smaller than a thickness of the first protection film.

8. The storage medium drive according to claim 6, wherein thickness of the first and second protection films gets reduced at a position closer to the outflow end of the rail.

9. A method of making a head slider, comprising:
forming a protection film on a top surface of a rail defined on a slider body, the protection film covering over a tip end of a head element at a position downstream of the rail, the head element exposed at a surface of an insulating non-magnetic film overlaid on an outflow end surface of the slider body; and
flattening a surface of the protection film on the insulating non-magnetic film while the head element is forced to protrude from the surface of the insulating non-magnetic film.
